(19) United States
(12) Patent Application Publication
(10) Pub. No.: US 2026/0158903 A1
(43) Pub. Date: Jun. 11, 2026

(54) CANISTER

(71) Applicant: AISAN KOGYO KABUSHIKI KAISHA, Obu-shi (JP)

(72) Inventors: Norihisa YAMAMOTO, Aichi-ken (JP); Akiko BAN, Tokai-shi (JP); Masamitsu HAYAKAWA, Anjo-shi (JP)

(73) Assignee: AISAN KOGYO KABUSHIKI KAISHA, Obu-shi (JP)

(21) Appl. No.: 19/398,422

(22) Filed: Nov. 24, 2025

(30) Foreign Application Priority Data
Dec. 5, 2024 (JP) 2024-212102

(51) Int. Cl. B60K 15/035

(52) U.S. Cl. CPC B60K 15/03504

(57) ABSTRACT

A canister includes a canister casing comprised of a tubular casing body and a cover. The casing body has an open end and a closed end. The cover is attached to the casing body to close the open end of the casing body. The cover includes a support plate portion, a joint portion to be joint to the open end of the casing body, and a tubular connecting portion that connects the support plate portion to the joint portion. The connecting portion is capable of being cut in a direction perpendicular to an axis of the connecting portion. An identification portion indicating a cutting region is provided on an outer peripheral surface of the casing body such that the cutting region is located within a range that overlaps with the connecting portion in an axial direction of the casing body.

### CROSS-REFERENCE TO RELATED APPLICATIONS

This application claims priority to Japanese patent application serial number 2024-212102 filed Dec. 5, 2024, which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to canisters.

One existing canister comprises a canister casing, and an adsorbent filled in the canister casing and configured to adsorb and desorb fuel vapor. The canister casing includes a tubular casing body with a closed end, and a cover configured to close an open end of the casing body. A retaining plate is provided within the casing body so as to be movable in a direction perpendicular to the retaining plate for holding the adsorbent within the casing body. The retaining plate is biased by a spring that is interposed between the cover and the retaining plate. The cover has a tubular connecting portion between a support plate portion supporting the spring and a joint portion joined to the open end of the casing body.

During recycling of the canister, internal components including the adsorbent, the retaining plate, and the spring could be removed by cutting the canister casing along a direction perpendicular to its axis. In this step, it is desirable to cut the canister casing without damaging the internal components, facilitating their easy extraction. To do this, it is necessary to cut the canister casing at the predetermined appropriate position, namely, at a position crossing the connecting portion of the cover. However, since the connecting portion is covered with the casing body, there is a risk of mistakenly cutting the canister casing at an incorrect position other than the predetermined position. For example, cutting of the canister casing at the incorrect position could cause damage the internal components, thereby reducing the recyclability of the canister. Therefore, there is a need for an improved canister that can prevent the canister casing from being cut at an incorrect position.

### SUMMARY OF THE INVENTION

In one aspect of this disclosure, a canister includes a canister casing, an adsorbent, a retaining plate, and a spring. The canister casing includes a tubular casing body and a cover. The casing body has an open end and a closed end. The cover is attached to the casing body to close the open end thereof. The adsorbent is filled in the canister casing and capable of adsorbing and desorbing fuel vapor. The retaining plate is provided within the casing body movable in a direction perpendicular to the retaining plate and configured to press the adsorbent into the canister casing. The spring is interposed between the cover and the retaining plate and configured to bias the retaining plate in a direction of pressing the adsorbent into the casing body. The cover includes a support plate portion supporting the spring, a joint portion to be joint to the open end of the casing body, and a tubular connecting portion that connects the support plate portion to the joint portion. The connecting portion is capable of being cut in a direction perpendicular to an axis of the connecting portion. An identification portion indicating a cutting region is provided on an outer peripheral surface of the casing body such that the cutting region is located within the range that overlaps with the connecting portion in the axial direction of the casing body.

### BRIEF DESCRIPTION OF THE DRAWINGS

FIG. 1 is a front view of a canister according to a first embodiment, partially shown in cross section.

FIG. 2 is an enlarged view of a part of the canister of FIG. 1.

FIG. 3 is a front view of a lower section of a canister according to a second embodiment.

FIG. 4 is an enlarged view of a part of the canister of FIG. 3.

### DETAILED DESCRIPTION

Some embodiments of the present disclosure are described below in reference to the drawings.

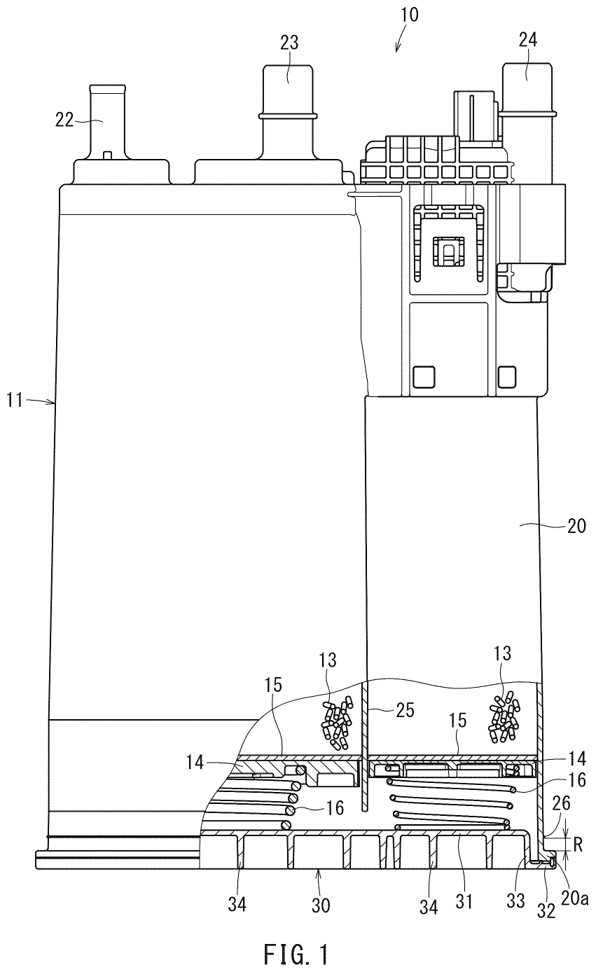

In a first embodiment, a canister 10 is configured to be mounted on a vehicle, such as automobile, for preventing leakage of fuel vapor from a fuel tank into the atmosphere. For the sake of explanation, a structure specific to the canister 10 will be described after explanation of the typical structure thereof. The top, bottom, left, and right directions of the canister 10 are defined based on the state shown in FIG. 1.

As shown in FIG. 1, the canister 10 comprises a resin-made canister casing 11. The canister casing 11 comprises a casing body 20 having a long rectangular tubular shape with an upper closed end, and a cover 30 that is attached to the casing body 20 for closing a lower open end of the casing body 20. The left-right dimension of the casing body 20 is larger than its front-back dimension.

A tank port 22, a purge port 23, and an atmospheric port 24 are arranged laterally on the upper surface of the casing body 20. The casing body 20 has a partition wall 25 that divides the hollow internal space into left and right adsorption chambers. The left adsorption chamber communicates with the tank port 22 and the purge port 23, while the right adsorption chamber communicates with the atmospheric port 24. A gap is formed between the partition wall 25 and the cover 30 to allow mutual communication between the two adsorption chambers. The tank port 22 is configured to communicate with the upper gas phase within the fuel tank of the vehicle. The purge port 23 is configured to communicate with the intake passage of the internal combustion engine. The atmospheric port 24 is configured to be open to the atmosphere.

Both adsorption chambers are filled with an adsorbent 13 for adsorbing and desorbing fuel vapor evaporated within the fuel tank. The adsorbent 13 may be composed of granular activated carbon. A gas-permeable retaining plate 14 is provided at the lower opening of each adsorption chamber such that the retaining plate 14 expands horizontally and is movable in the direction perpendicular to the retaining plate 14, i.e., the up-down direction. The retaining plates 14 hold the adsorbent 13 in the adsorption chambers. A gas-permeable filter 15 having a sheet-like shape is superimposed on the upper surface of each retaining plate 14. A spring 16 is interposed between each retaining plate 14 and the cover 30. The spring 16 is composed of a coil spring that biases the retaining plate 14 in the direction of pressing the adsorbent 13 into the adsorption chamber (upward direction).

The casing body 20 has an open end 20a at the lower end thereof. The open end 20a has a flange shape protruding radially outward and has a rectangular ring shape. The cover 30 has a support plate portion 31, a joint portion 32, and a connecting portion 33. The support plate portion 31 has a rectangular plate shape and supports both left and right springs 16. The joint portion 32 is joined to the open end 20a of the casing body 20 by welding, such as vibration welding. The connecting portion 33 has a rectangular tubular shape and can be cut along a direction perpendicular to its axis, i.e., the horizontal direction. The connecting portion 33 is positioned to protrude into the casing body 20 such that a rectangular ring-shaped gap is formed between the casing body 20 and the connecting portion 33 to avoid contact during vibration welding. The cover 30 has a plurality of reinforcing ribs 34 extending along the lower surface of the support plate portion 31. Each reinforcing rib 34 extends in the right-left direction or the front-back direction. Each reinforcing ribs 34 is integrally formed with the connecting portion 33 and/or another intersecting reinforcing ribs 34.

During recycling of the canister 10, to easily remove internal components including the adsorbent 13, the retaining plates 14, and the springs 16 without damaging them, it is necessary to cut the canister casing 11 at an appropriate cutting position, namely, at a position crossing the connecting portion 33 of the cover 30. However, since the existing canister lacks a feature indicating the appropriate cutting position on the canister casing, there is a risk that the canister casing is cut at an incorrect position. The canister 10 of this embodiment has following characteristic configurations to prevent the canister casing 11 from being cut at an incorrect position.

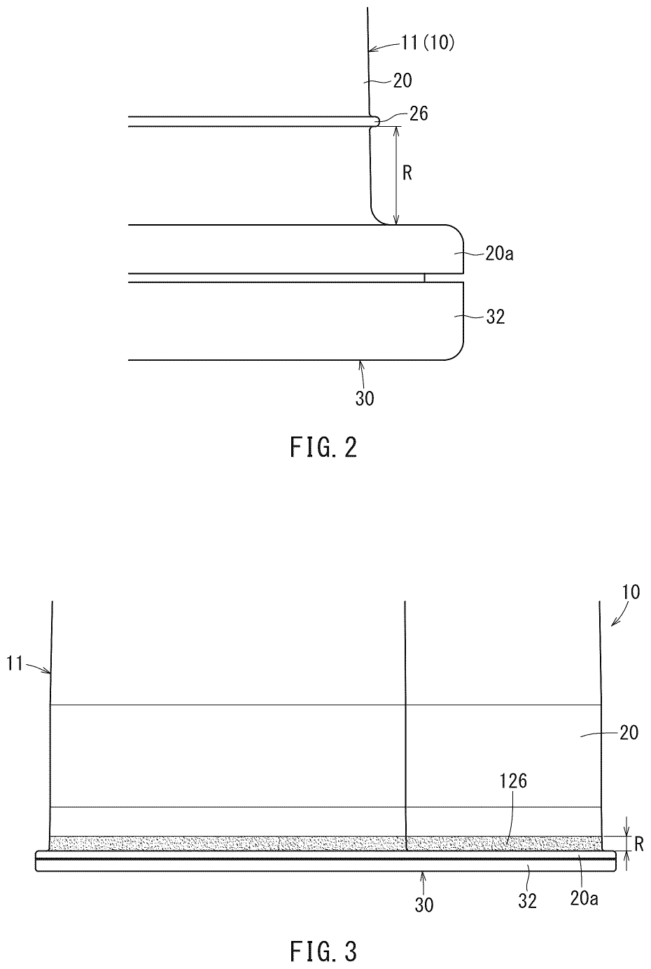

As shown in FIG. 2, the casing body 20 has an identification portion 26 on the outer peripheral surface of the casing body 20 to indicate a cutting region R. The identification portion 26 protrudes radially outward from the outer peripheral surface of the casing body 20 and continuously extends in the circumferential direction. The identification portion 26 and the open end 20a of the casing body 20 define the cutting region R therebetween. As shown in FIG. 1, the cutting region R is located within the range that overlaps with the connecting portion 33 of the cover 30 in the axial direction of the canister casing 11.

According to the first embodiment, the cutting region R corresponding to the position of the connecting portion 33 is indicated by the identification portion 26 that is provided on the outer peripheral surface of the casing body 20. Thus, by cutting the canister casing 11 in the cutting region R along a direction perpendicular to its axis during recycling of the canister 10, it is possible to prevent the canister casing 11 from being cut at the incorrect position. Accordingly, the support plate portion 31 can be removed to open the cover-side end of the casing body 20 without damaging internal components including the adsorbent 13, the retaining plates 14, and the springs 16. Therefore, the internal components can be easily removed to improve the recyclability of the canister 10.

The identification portion 26 can indicate the boundary of the cutting region R by its protruding shape.

The cutting region R can be easily identified by the identification portion 26 continuously extending along the outer peripheral surface of the casing body 20 in the circumferential direction.

The identification portion 26 may be formed as a concave groove. The identification portion 26 may be formed to intermittently extend along the outer peripheral surface of the casing body 20 in the circumferential direction.

Next, a second embodiment will be described. The second embodiment corresponds to the first embodiment in which the identification portion 26 is modified. Accordingly, the modifications will be described, while the same configurations will not be explained.

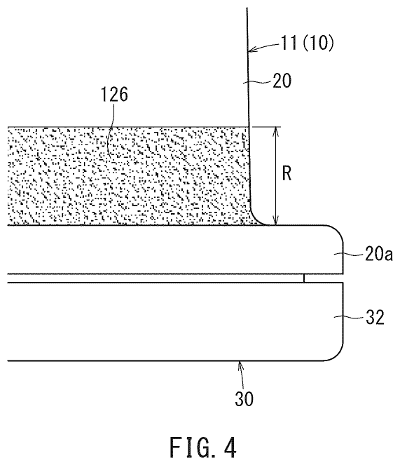

In the second embodiment, the identification portion 126 extends over the same range as the cutting region R in the axial direction of the canister casing 11, i.e., the up-down direction. As shown in FIGS. 3 and 4, the identification portion 126 of the second embodiment has a surface roughness different from that of the surface in areas other than the cutting region R. Specifically, the identification portion 126 has a surface roughness greater than that of the surface other than the cutting region R. In other words, the identification portion 126 has fine irregularities on its surface, while the other area has a smooth surface. The identification portion 126 is continuously formed on the casing body 20 in the circumferential direction. The identification portion 126 may be formed simultaneously during resin molding of the casing body 20 or may be formed by surface treatment after resin molding of the casing body 20.

The second embodiment also achieves the same functions and effects as the first embodiment.

The identification portion 126 can indicate the cutting region R based on the difference of the surface roughness.

The cutting region R can be easily identified by the identification portion 126 continuously extending along the outer peripheral surface of the casing body 20 in the circumferential direction.

The identification portion 126 may have the surface roughness less than that of the area other than the identification portion 126. The identification portion 126 may be formed to intermittently extend along the outer peripheral surface of the casing body 20 in the circumferential direction.

The present disclosure is not limited to the above-described embodiments. A person skilled in the art can make various substitutions, improvements, and modifications without departing from the scope of the present disclosure. For example, the cutting region R may be set to an area suitable for cutting based on the shape of the casing body 20 and the cover 30. If the open end 20a of the casing body 20 does not have a flange shape, the cutting region R may be set at a position overlapping with the connecting portion 33 of the cover 30 in the axial direction of the canister casing 11.

The present disclosure includes various aspects as follows. In a first aspect of this disclosure, a canister includes a canister casing, an adsorbent, a retaining plate, and a spring. The canister casing includes a tubular casing body and a cover. The casing body has an open end and a closed end. The cover is attached to the casing body to close the open end of the casing body. The adsorbent is filled in the canister casing and capable of adsorbing and desorbing fuel vapor. The retaining plate is provided within the casing body movable in a direction perpendicular to the retaining plate and configured to press the adsorbent into the canister casing. The spring is interposed between the cover and the retaining plate and configured to bias the retaining plate in a direction of pressing the adsorbent into the casing body. The cover includes a support plate portion supporting the spring, a joint portion to be joint to the open end of the casing body, and a tubular connecting portion that connects the support plate portion to the joint portion. The connecting portion is capable of being cut in a direction perpendicular to an axis of the connecting portion. An identification portion indicating a cutting region is provided on an outer peripheral surface of the casing body such that the cutting region is located within the range that overlaps with the connecting portion in an axial direction of the casing body.

In accordance with the first aspect, the identification portion formed on the outer peripheral surface of the casing body shows the cutting region overlapping with the connecting portion. Due to this configuration, by cutting the canister casing in the cutting region along a direction perpendicular to the axis of the canister casing during recycling of the canister, it is possible to prevent the canister casing from being cut at an incorrect position. Accordingly, the support plate portion can be removed to open the cover-side end of the casing body without damaging internal components including the adsorbent, the retaining plate, and the spring. Therefore, the internal components can be easily removed to improve the recyclability of the canister.

In a second aspect, the identification portion may have a convex or concave shape defining a boundary of the cutting region.

In accordance with the second aspect, the boundary of the cutting region can be easily identified by the convex or concave shape of the identification portion.

In a third aspect, the identification portion may have a surface roughness different from that of area other than the identification portion.

In accordance with the third aspect, the cutting region is distinguishable through both visual inspection and tactile sensation of the identification portion.

In a fourth aspect, the identification portion may extend continuously or intermittently along the outer peripheral surface of the casing body in the circumferential direction.

In accordance with the fourth aspect, the cutting region can be identified by the identification portion regardless of the circumferential orientation.

What is claimed is:

1. A canister, comprising:
a canister casing including a tubular casing body and a cover, the casing body having an open end and closed end, and the cover being attached to the casing body to close the open end of the casing body;
an adsorbent filling the canister casing and configured to adsorb and desorb fuel vapor;
a retaining plate provided within the casing body movable in a direction perpendicular to the retaining plate and configured to press the adsorbent into the canister casing; and
a spring interposed between the cover and the retaining plate, wherein the spring is configured to bias the retaining plate in a direction of pressing the adsorbent,
wherein the cover includes a support plate portion supporting the spring, a joint portion to be joint to the open end of the casing body, and a tubular connecting portion that connects the support plate portion to the joint portion,
wherein the connecting portion is configured to be cut in a direction perpendicular to an axis of the connecting portion, and
wherein an identification portion indicating a cutting region is provided on an outer peripheral surface of the casing body such that the cutting region is located within a range that overlaps with the connecting portion in an axial direction of the casing body.

2. The canister of claim 1, wherein the identification portion has a convex or concave shape defining a boundary of the cutting region.

3. The canister of claim 1, wherein the identification portion has a surface roughness different from that of area other than the identification portion.

4. The canister of claim 2, wherein the identification portion extends continuously or intermittently along the outer peripheral surface of the casing body in a circumferential direction of the casing body.

5. The canister of claim 3, wherein the identification portion extends continuously or intermittently along the outer peripheral surface of the casing body in a circumferential direction of the casing body.
